(19) United States
(12) Patent Application Publication
(10) Pub. No.: US 2014/0097070 A1
(43) Pub. Date: Apr. 10, 2014

(54) SWITCH IDENTIFICATION COVER, SHEATH, OR BOOT

(71) Applicant: Sean Michael McDonnell, Burlington, CT (US)

(72) Inventor: Sean Michael McDonnell, Burlington, CT (US)

(21) Appl. No.: 14/044,935

(22) Filed: Oct. 3, 2013

Related U.S. Application Data
(60) Provisional application No. 61/710,680, filed on Oct. 6, 2012.

(51) Int. Cl. H01H 9/18

(52) U.S. Cl. CPC H01H 9/18
USPC 200/308

(57) ABSTRACT

The present invention generally relates to an accessory for light, appliance, and other activation switches and switch panels. Specifically, the invention relates to a switch identification cover, sheath, boot, or similar covering that is configured to attach to a switch in order to make that switch more readily identifiable. Throughout this disclosure, the invention may be referred to as a switch identification cover, switch identification sheath, or switch identification boot, as well as any combination or derivative thereof.

### CROSS REFERENCE TO RELATED APPLICATIONS

This application claims the benefit of U.S. Provisional Patent Application No. 61/710,680, filed Oct. 6, 2012, the entire disclosure of which is incorporated herein by reference.

### FIELD OF THE INVENTION

The present invention generally relates to an accessory for light, appliance, and other activation switches and switch panels. Specifically, the invention relates to a switch identification cover, sheath, boot, or similar covering that is configured to attach to a switch in order to make that switch more readily identifiable.

### BACKGROUND OF THE INVENTION

In the majority of homes and businesses around the world, a switch panel with multiple switches can typically be found. It is a common experience for users of said switches to have difficulties identifying and remembering what each switch controls or what each switch turns on and off. For example, a user may flip a switch expecting it to turn on a light only to be unpleasantly surprised when the switch actually turns on a loud garbage disposal. Alternatively the switch might turn off a television that another person was happily watching. Many other examples could be listed to demonstrate the fact that users of switches could benefit from a product which could assist them in identifying and/or remembering the function of switches

Therefore, there is a need in the art for a switch identification cover, sheath, or boot, that helps a person more easily identify the appropriate switch for a particular operation. It should be noted that such a switch identification cover, sheath, or boot would not only be beneficial in circumstances where there are multiple switches, but could also when installed onto a single stand-alone switch. These and other features and advantages of the present invention will be explained and will become obvious to one skilled in the art through the summary of the invention that follows.

### SUMMARY OF THE INVENTION

The present invention provides an apparatus for more readily identifying a switch or panel of switches. In a preferred embodiment, the apparatus is a cover, sheath, boot, or similar covering that is attached to the switch to aid in identification of the switch. In the preferred embodiment, the switch identification cover, sheath, or boot may include both visual and tactile/haptic elements that are used to distinguish one switch from another.

According to an embodiment of the present invention, a switch identification cover apparatus includes: one or more side walls interconnected to form a containment space configured to enclose at least a portion of a switch such that the switch identification cover apparatus is securely retained upon the switch.

According to an embodiment of the present invention, the switch identification cover apparatus further includes an end wall interconnected with the one or more side walls to from the containment space, wherein the end wall further defines the containment space.

According to an embodiment of the present invention, the switch identification cover apparatus further includes one or more identification features, wherein one or more identification features are selected from a group of identification features comprising one or more holes, one or more symbols, one or more curved side walls, and one or more haptic identifiers.

According to an embodiment of the present invention, the one or more identification features are configured in the one or more side walls.

According to an embodiment of the present invention, the one or more identification features are configured in the end wall.

According to an embodiment of the present invention, the switch identification cover apparatus further includes a lip, wherein the lip is connected to one or more of the one or more side walls and is configured to assist a user with installation of the switch identification cover apparatus.

According to an embodiment of the present invention, the switch identification cover apparatus further includes a flap, wherein the flap is connected to and extends one or more of the one or more side walls and is configured to securely retain the switch identification cover apparatus upon the switch.

According to an embodiment of the present invention, the switch identification cover apparatus further includes a flange, wherein the flange is an extension connected to each of the one or more side walls that seals the switch behind a face plate when the switch identification cover apparatus is arranged over the switch and behind the face plate covering the switch.

According to an embodiment of the present invention, the flange is further configured with an accordion-like structure to provide sufficient flexibility so as to allow the switch to be operated.

According to an embodiment of the present invention, the switch identification cover apparatus further includes a rib, wherein the rib is attached to one or more of the one or more side walls and is configured to secure the switch identification cover apparatus on the switch by physically engaging with one or more edges of the switch.

According to an embodiment of the present invention, a switch identification cover apparatus includes: a front wall interconnected to a rear wall; wherein the rear wall is configured with an adhesive component, wherein the adhesive component is configured to securely affix the rear wall of the switch identification cover apparatus to a switch surface.

According to an embodiment of the present invention, the front wall is further configured with a tactile surface element to identify and enhance the grip characteristics of the switch surface.

According to an embodiment of the present invention, a switch identification cover apparatus further includes one or more side walls interconnected between said front wall and said rear wall.

According to an embodiment of the present invention, the switch identification cover apparatus is bar that forms a shaped-loop with a void formed on the interior portion of said shaped-loop.

According to an embodiment of the present invention, the shaped-loop is selected from a group shaped-loops comprising circle shaped-loops, squares shaped-loops, rectangle shaped-loops, triangle shaped-loops, oval shaped-loops, and free-form shaped loops.

According to an embodiment of the present invention, the adhesive component is further configured on said one or more side walls.

According to an embodiment of the present invention, the adhesive component is a temporary adhesive.

According to an embodiment of the present invention, the adhesive component is a permanent adhesive

According to an embodiment of the present invention, a method for identifying a switch includes the steps of: attaching to a switch a switch identification cover apparatus comprising one or more side walls interconnected to form a containment space configured to enclose at least a portion of the switch such that the switch identification cover apparatus is securely retained upon the switch and identifying the switch based at least in part on the switch cover identification cover apparatus that is attached to the switch.

According to an embodiment of the present invention, the switch identification cover, sheath, or boot comprising any feature described, either individually or in combination with any feature in any embodiment, may have one or more of the following advantages: 1) assisting users in identifying the function of a conventional switch, 2) assisting users in remembering the function a conventional switch, 3) assisting users in remembering the function of switches that they do not interact with on a regular basis, 4) assisting users in remembering the function of switches that they do interact with on a regular basis, 5) assisting users in identifying the function of a switch the first time they interact with it, 6) allowing users to more consistently choose the correct switch for a specifically desired operating function, 7) reducing the amount of time required to locate the correct switch, 8) assisting users in locating a switch in the dark, 9) reducing the likelihood of accidentally using the wrong switch, 10) reducing the likelihood of injuries that could be caused by using the wrong switch, 11) improving a user's grip when interacting with a switch, 12) ease of use when compared to existing products, and 13) easier to manufacture or mass produce when compared to existing products.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

In the drawings, closely related figures have the same number but different alphabetical suffixes.

FIG. 1 is a perspective view of a first embodiment of a switch identification cover in accordance with an embodiment of the present invention;

FIG. 2 is a front perspective view of a first embodiment of a switch identification cover in accordance with an embodiment of the present invention;

FIG. 3 is a rear perspective view of a first embodiment of a switch identification cover in accordance with an embodiment of the present invention;

FIG. 4 is a top view of a first embodiment of a switch identification cover in accordance with an embodiment of the present invention;

FIG. 5 is a side view of a first embodiment of a switch identification cover in accordance with an embodiment of the present invention;

FIG. 6 is a perspective view of the first embodiment of a switch identification cover in accordance with an embodiment of the present invention;

FIG. 7 is a cross-sectional side view of the first embodiment of a switch identification cover in accordance with an embodiment of the present invention;

FIG. 8 is a front perspective view of an alternative embodiment of a switch identification cover in accordance with an embodiment of the present invention;

FIG. 9 is a rear perspective view of an alternative embodiment of a switch identification cover in accordance with an embodiment of the present invention;

FIG. 10 is a perspective view of an alternative embodiment of a switch identification cover in accordance with an embodiment of the present invention;

FIG. 11 is a front perspective view of an alternative embodiment of a switch identification cover in accordance with an embodiment of the present invention;

FIG. 12 is a rear perspective view of an alternative embodiment of a switch identification cover in accordance with an embodiment of the present invention;

FIG. 13 is a perspective view of an alternative embodiment of a switch identification cover in accordance with an embodiment of the present invention;

FIGS. 14A-C are perspective views of alternative embodiments of a switch identification cover in accordance with an embodiment of the present invention;

FIG. 15 is a perspective view of an alternative embodiment of a switch identification cover in accordance with an embodiment of the present invention;

FIG. 16 is a perspective view of an alternative embodiment of a switch identification cover in accordance with an embodiment of the present invention;

FIG. 17 is a front perspective view of an alternative embodiment of a switch identification cover in accordance with an embodiment of the present invention;

FIG. 18 is a rear perspective view of an alternative embodiment of a switch identification cover in accordance with an embodiment of the present invention;

FIG. 19 is an perspective view of an alternative embodiment of a switch identification cover in accordance with an embodiment of the present invention;

FIG. 20 is a front perspective view of an alternative embodiment of a switch identification cover in accordance with an embodiment of the present invention;

FIG. 21 is a rear perspective view of an alternative embodiment of a switch identification cover in accordance with an embodiment of the present invention;

FIG. 22 is a perspective view of an alternative embodiment of a switch identification cover in accordance with an embodiment of the present invention;

FIG. 23 is a front perspective view of an alternative embodiment of a switch identification cover in accordance with an embodiment of the present invention;

FIG. 24 is a rear perspective view of an alternative embodiment of a switch identification cover in accordance with an embodiment of the present invention;

FIG. 25 is a perspective view of an alternative embodiment of a switch identification cover in accordance with an embodiment of the present invention;

FIGS. 26A-C are perspective views of an alternative embodiment of a switch identification cover in accordance with an embodiment of the present invention;

FIG. 27 is a front perspective view of an alternative embodiment of a switch identification cover in accordance with an embodiment of the present invention;

FIG. 28 is a rear perspective view of an alternative embodiment of a switch identification cover in accordance with an embodiment of the present invention;

FIG. 29 is a perspective view of an alternative embodiment of a switch identification cover in accordance with an embodiment of the present invention;

FIG. 30 is a perspective view of an alternative embodiment of a switch identification cover in accordance with an embodiment of the present invention;

FIG. 31 is a front perspective view of an alternative embodiment of a switch identification cover in accordance with an embodiment of the present invention;

FIG. 32 is a rear perspective view of an alternative embodiment of a switch identification cover in accordance with an embodiment of the present invention;

FIG. 33 is a perspective view of an alternative embodiment of a switch identification cover in accordance with an embodiment of the present invention;

FIG. 34 is a front perspective view of an alternative embodiment of a switch identification cover in accordance with an embodiment of the present invention;

FIG. 35 is a rear perspective view of an alternative embodiment of a switch identification cover in accordance with an embodiment of the present invention;

FIG. 36 is a cross-sectional side view of an alternative embodiment of a switch identification cover in accordance with an embodiment of the present invention;

FIG. 37 is a front perspective view of an alternative embodiment of a switch identification cover in accordance with an embodiment of the present invention;

FIG. 38 is a rear perspective view of an alternative embodiment of a switch identification cover in accordance with an embodiment of the present invention; and

FIG. 39 is a perspective view of an alternative embodiment of a switch identification cover in accordance with an embodiment of the present invention.

### DETAILED SPECIFICATION

The present invention generally relates to an accessory for light, appliance, and other activation switches and switch panels. Specifically, the invention relates to a switch identification cover, sheath, boot, or similar covering that is configured to attach to a switch in order to make that switch more readily identifiable. Throughout this disclosure, the invention may be referred to as a switch identification cover, switch identification sheath, or switch identification boot, as well as any combination or derivative thereof.

### Preferred Embodiment

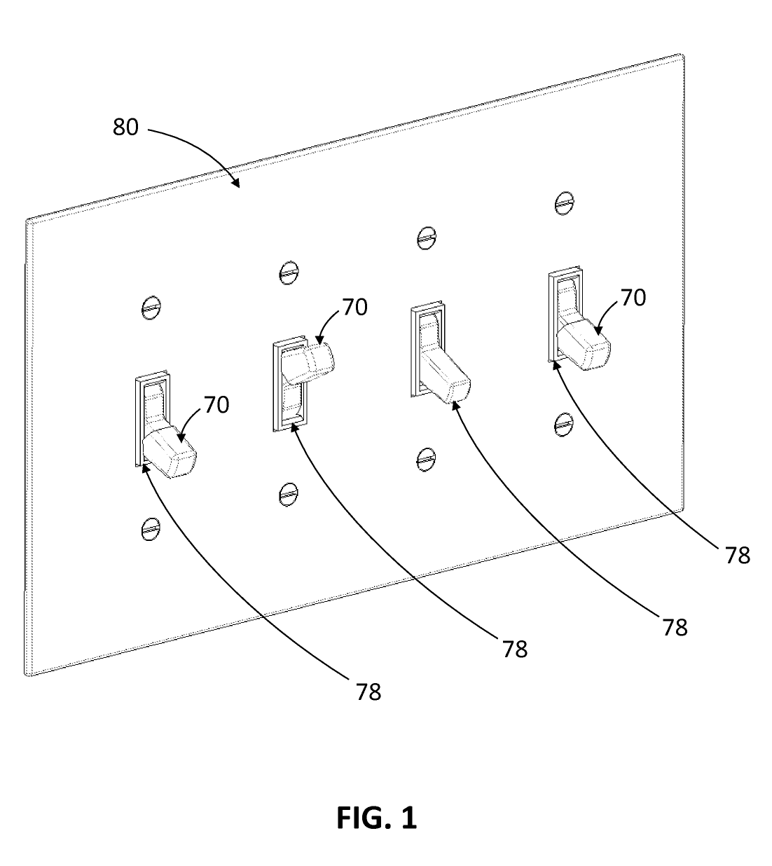

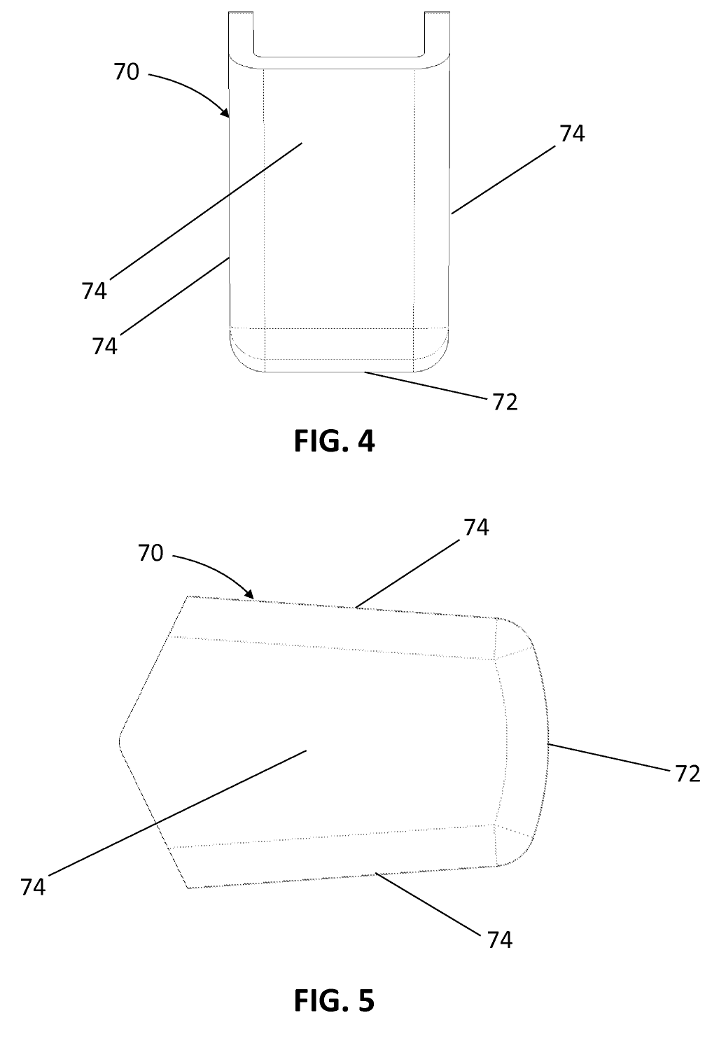

Turning now to FIGS. 1-7, a preferred embodiment of a switch identification cover. While this embodiment may operate most efficiently, other and later disclosed embodiments also operate effectively.

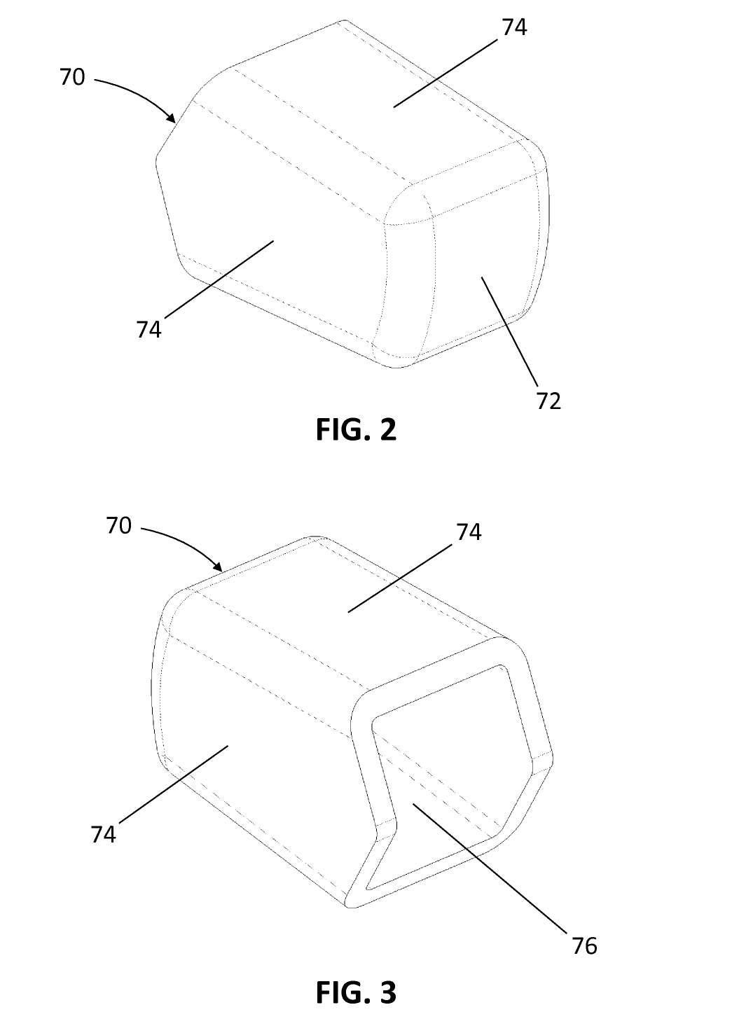

Turning now to FIG. 1, an illustration of a switch identification cover in place on a switch, in accordance with an embodiment of the present invention. A conventional panel cover or face plate 80 is placed in front of a conventional light switch or switch 78. In this embodiment there are four separate switches 78. In other embodiments there may be more than four switches 78 or there may be less than four switches 78. A switch identification cover 70 is placed onto three of the switches 78. In other embodiments the switch identification cover, sheath, or boot 70 may be placed onto more of the switches 78 or less of the switches 78. This embodiment of the switch identification cover, sheath, or boot 70 is illustrated from different perspectives in FIGS. 2-7.

Turning now to FIGS. 2-5, various views of the switch identification cover, in accordance with an embodiment of the present invention. At the end of the switch identification cover, sheath, or boot 70 is a tip, wall, or end wall 72. The end wall 72 in this embodiment has a curved square shape. In this embodiment the shape of the end wall 72 is configured to match the size, shape, and contour of the switch 78. In other embodiments the end wall 72 may be a different size or shape such as a circle, diamond, hexagon, or some other shape. One of ordinary skill in the art would appreciate that the switch identification cover in this embodiment could be configured in numerous shapes and sizes, and embodiments of the present invention are contemplated for use with any such size or shape configuration.

According to an embodiment of the present invention, connected to the end wall 72 is a panel, or side wall 74. In this embodiment there are four side walls 74 which connect to one another and connect to the end wall 72. The side walls 74 of this embodiment are curved and match the shape of the switch 78. In other embodiments the side walls 74 may be a different size or shape. In other embodiments there may be more or less than four side walls 74. Together, the side walls 74 and the end wall 72, surround a holding space, or a containment space 76.

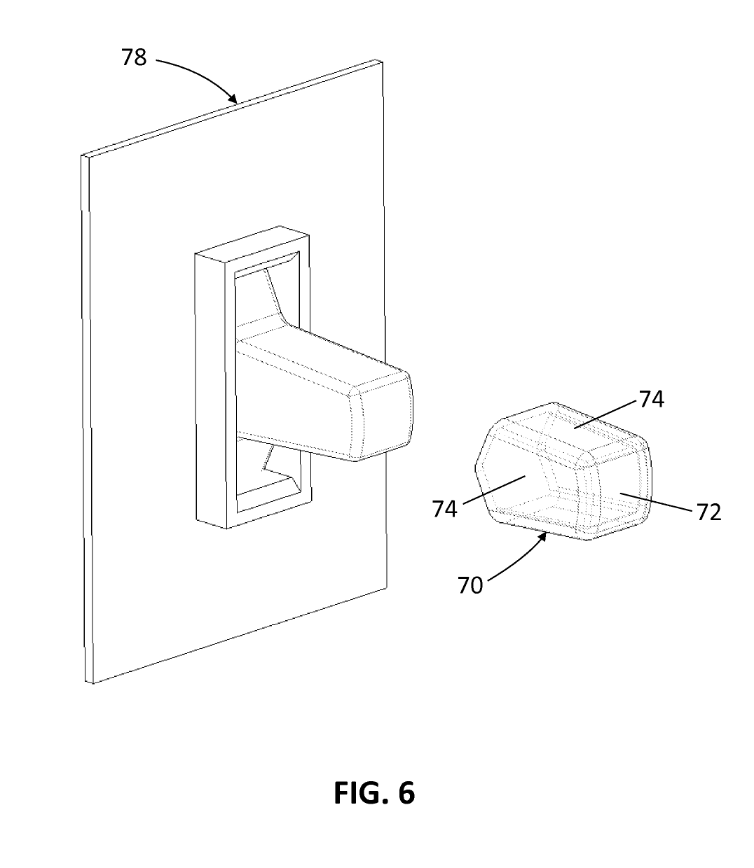

Turning now to FIG. 6, an illustration of a switch identification cover aligned with a switch, in accordance with an embodiment of the present invention. In this illustration, the switch identification cover, sheath, or boot 70 is aligned with the switch 78, such that the four side walls 74 and the end wall 72 are positioned to fit over the projected portion of the switch 78.

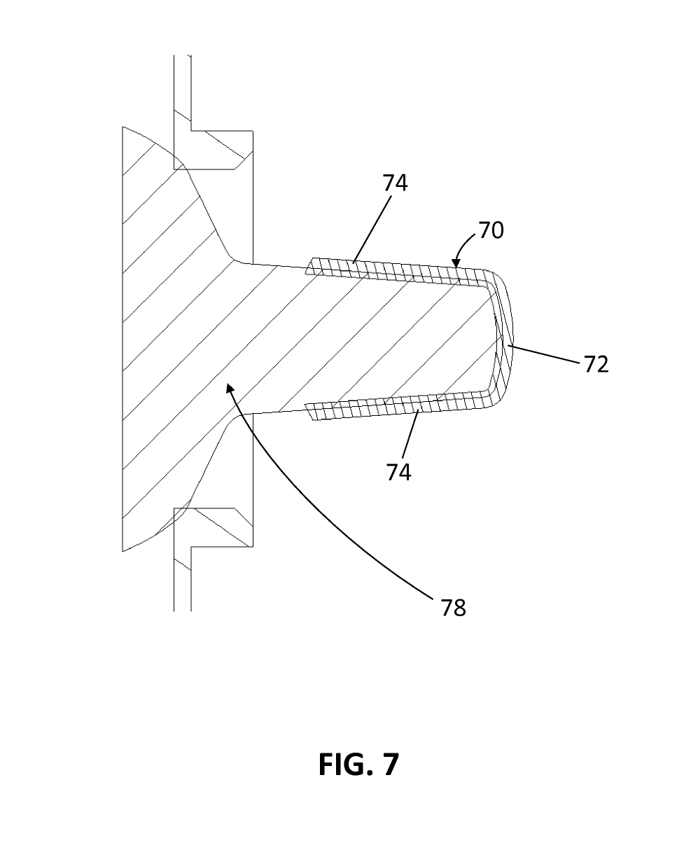

Turning now to FIG. 7, a cross sectional view of the switch identification cover in place on a switch, in accordance with an embodiment of the present invention. In this embodiment the containment space 76 is approximately ten percent smaller than the switch 78 onto which the switch identification cover, sheath, or boot 70 it is placed. The reason for this will be explained in the Operation section of this document. In other embodiments the containment space 76 may be the same size as the switch 78, it may be larger than the switch 78, or it may be more than ten percent smaller than the switch 78.

According to an embodiment of the present invention, the switch identification cover, sheath, or boot 70 of this embodiment be made of silicone, thermoplastic elastomer, rubber, or any other suitable plastic. However, many other materials are also suitable for example wood or ceramic or metal. The material of the switch identification cover, sheath, or boot 70 may also contain additives which would allow the switch identification cover, sheath, or boot 70 to glow in the dark. Alternatively the switch identification cover, sheath, or boot 70 may be coated or painted to allow it to glow in the dark. In this embodiment the switch identification cover, sheath, or boot 70 may be manufactured using an injection molding process. However, many other manufacturing processes are also suitable. For example, thermoforming or compression molding would also be suitable manufacturing processes. One of ordinary skill in the art would appreciate that there are many materials and manufacturing processes suitable for creating switch identification covers, sheaths, or boots, and embodiments of the present invention are contemplated for use with any such material or manufacturing process.

### Exemplary Operation of the Preferred Embodiment

According to an embodiment of the present invention, the switch identification cover, sheath, or boot 70 can be easily installed onto any pre-existing switch 78. FIG. 6 shows an exploded view of this embodiment. In this view it can be seen how a user would simply attach the switch identification cover, sheath, or boot 70 to a switch 78. One method could be to slide the switch identification cover, sheath, or boot 70 over the switch 78. If this embodiment is made from a flexible material another assembly method could be to flip the switch identification cover, sheath, or boot 70 inside out, and then place the inside of the end wall 72 up against the switch 78. Then while maintaining said position the user would flip the switch identification cover, sheath, or boot 70 back to the right side out and the switch identification cover, sheath, or boot 70 would then be successfully assembled onto the switch 78.

FIG. 7 shows a cross sectional view of this embodiment. As previously noted, in this embodiment the containment space 76 is roughly ten percent smaller than the switch 78. In other embodiments, the space 76 could be any amount smaller than the switch 78 (e.g., five percent, 15 percent, 20 percent). One of ordinary skill in the art would appreciate that the space 76 could be on varying sizes and embodiments of the present invention are configured to work with a space 76 of any appropriate size. If this embodiment is made from a flexible material, it can now be understood why this smaller containment space 76 would be advantageous. A tight fit between the switch identification cover, sheath, or boot 70 and the switch 78 could ensure a more secure and robust attachment such that the switch identification cover, sheath, or boot 70 will be less likely to inadvertently fall off of the switch 78.

According to an embodiment of the present invention, users of this embodiment can more easily identify and remember the function of switches for a number of reasons. First of all, the switch identification cover, sheath, or boot may be manufactured in a number of different colors. Because of this, the user could now associate a specific color in their memory with a specific function of the switch. Additionally, the user may be able to identify specific switches simply because one or more switches has the switch identification cover, sheath, or boot attached to them while other switches may not. Also, going beyond the visual aspect of memory and identification, there is a haptic or touch and feel element to the operation of the switch identification cover, sheath, or boot. A switch which has the switch identification cover, sheath, or boot assembled on to it could feel different to the user than a switch 78 without the switch identification cover, sheath, or boot attached to it. Therefore the user could associate that feeling, or difference in feelings between switches, with a memory of the function of each switch. As a final example, if this embodiment is produced using glow in the dark additives, coatings, or paints, the user could be able to more easily locate and identify their switch in the dark. One of ordinary skill in the art would appreciate there are many useful functions and designs for a switch identification cover, sheath, or boot, and embodiments of the present invention are contemplated for use with any such design or function.

According to an embodiment of the present invention, the switch identification cover, sheath, or boot could also be used to prevent injuries. In a preferred embodiment, the switch identification cover, sheath, or boot could prevent injuries by identifying, reminding, and/or alerting users that a switch will control something which could potentially be hazardous. In an additional preferred embodiment, the switch identification cover, sheath, or boot could be made from an electrically insulating material, to prevent the user from being electrically shocked either from static electricity buildup or from an electrical short from the switch.

According to an embodiment of the present invention, the switch identification cover, sheath, or boot could be utilized to improve a person's grip on a switch. In a preferred embodiment, the switch identification cover, sheath, or boot may be made from a material with a higher coefficient of friction than the switch, therefore improving the user's ability to grip onto this embodiment while actuating the switch. In other words the switch identification cover, sheath, or boot could prevent the user from failed switch actuation which was caused by the user's grip slipping off of the switch.

According to an embodiment of the present invention, the switch identification cover, sheath, or boot would allow users to more easily identify and remember the function of switches, thereby saving time and preventing frustration. This would be the case not only for the user of the switch identification cover, sheath, or boot but additionally for any other bystanders who may be affected by the function of the switch which is being operated.

### Alternate Embodiments

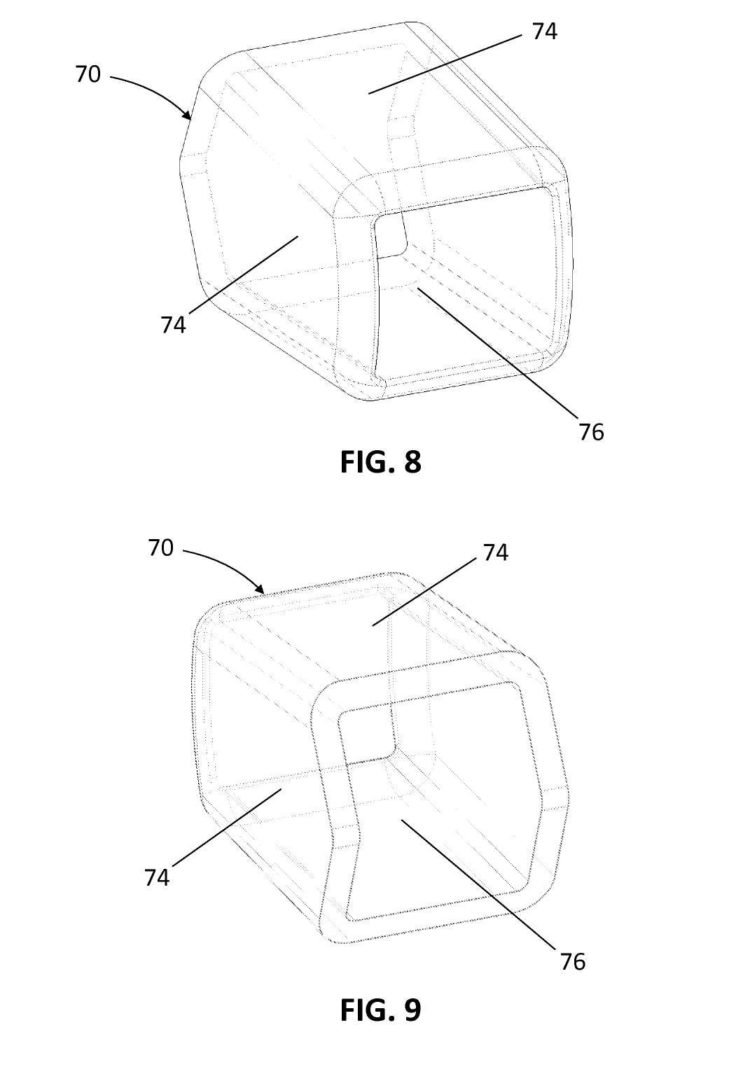

Turning now to FIGS. 8-10, an additional embodiment of the switch identification cover, sheath, or boot is illustrated.

Turning now to FIGS. 8-9, isometric views of the switch identification cover, sheath, or boot 70, in accordance with an embodiment of the present invention. In this embodiment there is no end wall. The side walls 74 are simply connected to one another to form the containment space 76.

This embodiment may be easier to assemble onto a switch. Additionally this embodiment may have a more preferable aesthetic design because the switch identification cover, sheath, or boot does not protrude as far out from the end of the switch as some other embodiments may. Additionally this embodiment may be more ergonomic.

Also, this embodiment may be easier to manufacture. In addition, because this embodiment may use less material, it could also be lower cost to manufacture.

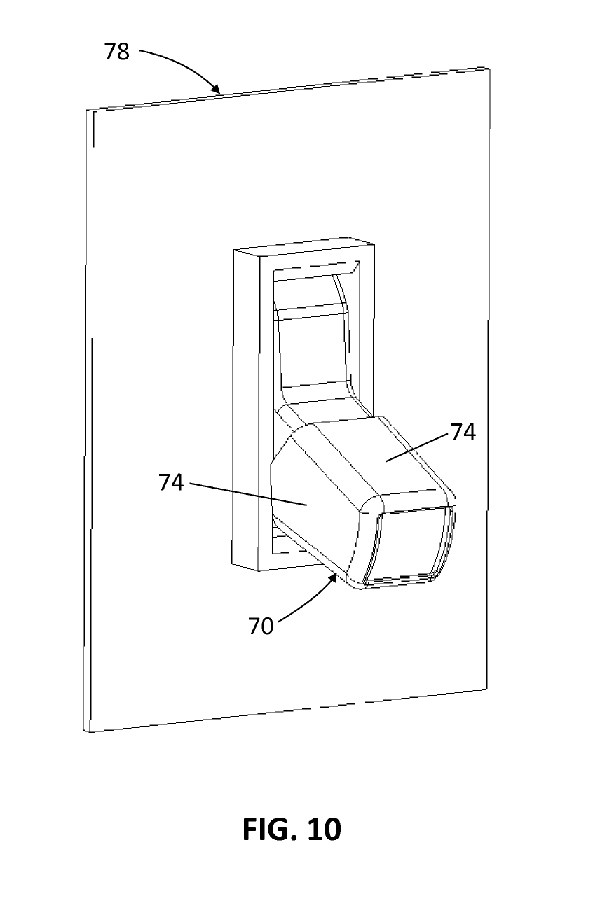

Turning now to FIG. 10, an illustration of the switch identification cover, sheath, or boot 70 attached to a switch 78, in accordance with this embodiment of the present invention.

### Additional Embodiment

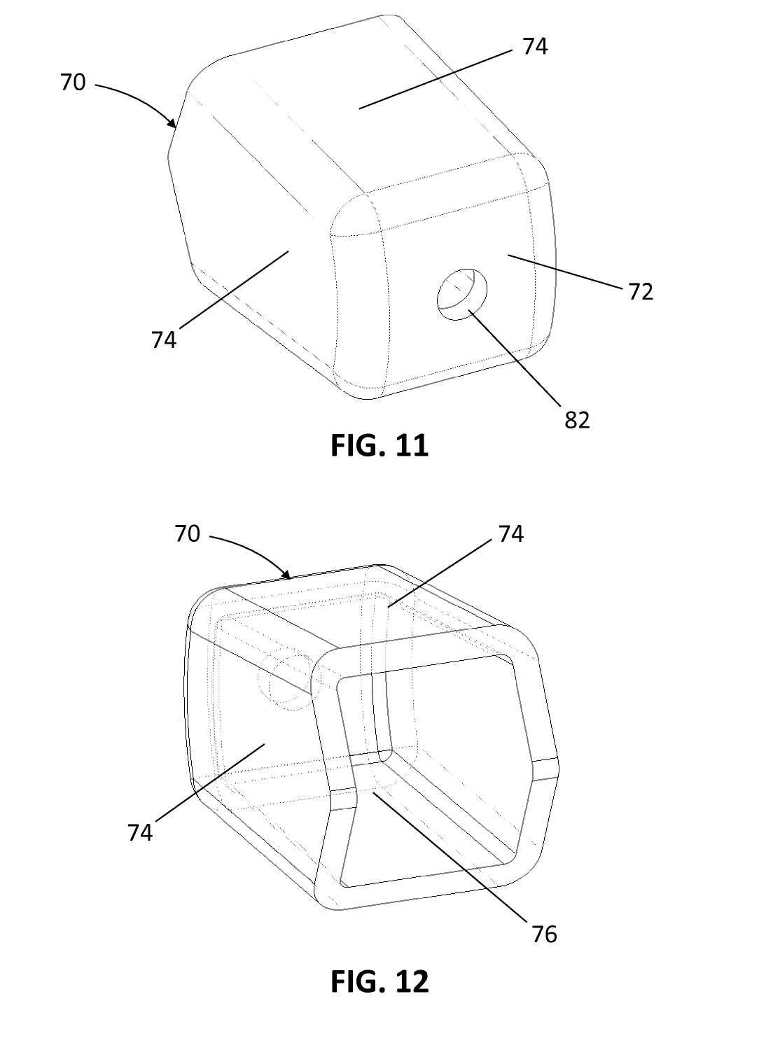

Turning now to FIGS. 11-13, an additional embodiment of the switch identification cover, sheath, or boot is illustrated.

Turning now to FIGS. 11-12, isometric views of the switch identification cover, sheath, or boot 70, in accordance with an embodiment of the present invention. In this embodiment there is a hole 82 through the end wall 72. In this embodiment the hole 82 has a circular shape but in other embodiments the hole 82 may be a different shape or size.

The benefit of the hole 82 is that a vacuum or suction cup type of attachment may be achieved when assembling the switch identification cover, sheath, or boot 70 to the switch 78. This could allow for a more secure and robust attachment of the switch identification cover, sheath, or boot 70 to the switch 78. This vacuum attachment could make the switch identification cover, sheath, or boot 70 less likely to inadvertently fall off of the switch 78.

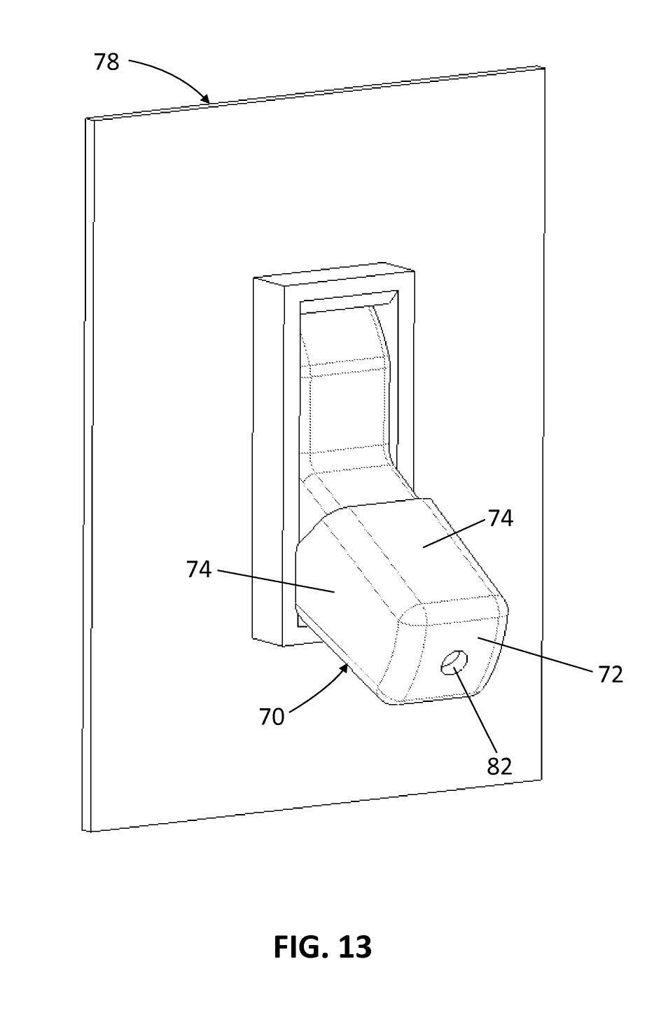

Turning now to FIG. 13, an illustration of the switch identification cover, sheath, or boot 70 attached to a switch 78, in accordance with this embodiment of the present invention.

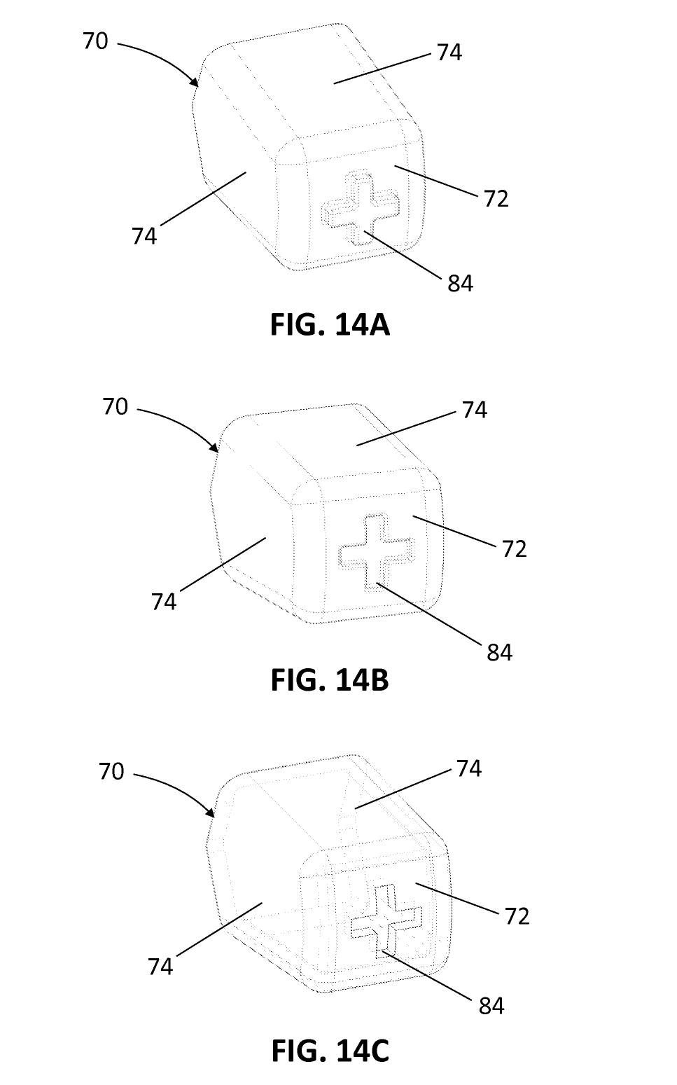

Turning now to FIGS. 14-16, an additional embodiment of the switch identification cover, sheath, or boot is illustrated.

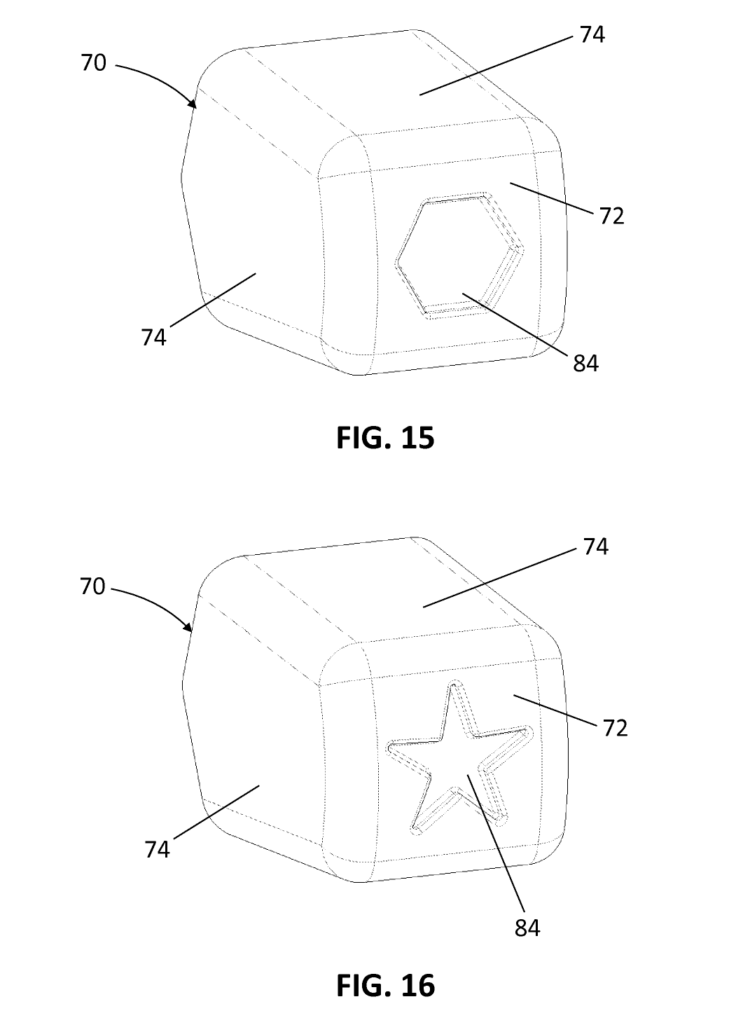

Turning now to FIGS. 14-16, isometric views of the switch identification cover, sheath, or boot 70, in accordance with an embodiment of present invention. In this embodiment there is an icon or symbol 84 on the end wall 72. The symbol 84 may be embossed or in other words a protrusion, as shown in FIG. 14A. The symbol 84 may be debossed or in other words cut into material, as shown in FIG. 14B. Or the symbol 84 may be a through hole or in other words cut through the end wall 72 completely, as shown in FIG. 14C. The symbol 84 may also be on any or all of the side walls 74 instead of, or in addition to, being on the end wall 72. FIGS. 14A-C show the symbol 82 having a cross type of shape. In other embodiments the symbol 84 could be a different shape or size. For example, FIG. 15 shows the symbol 84 having a hexagon shape and FIG. 16 shows the symbol 84 having a star shape. In this embodiment there is only one symbol 84 on the switch identification cover, sheath, or boot 70. However in other embodiments there may be more than one symbol 84. In addition, the entire switch identification cover, sheath, or boot 70 could be designed in a way that its overall geometry is the shape of an identifiable symbol (as opposed to having the symbol 82 imposed onto the side walls 74 or the end wall 72). For example the switch identification cover, sheath, or boot 70 could be made in the shape of a symbol for a light bulb or could be made in the shape of a symbol for a television. The symbol 84 may allow the user to more easily identify the function of the switch 78. Additionally, the symbol 84 may also allow the user to more easily remember the function of the switch 78. One of ordinary skill in the art would appreciate a variety of shapes and symbols could be placed on the switch identification cover, and embodiments of the present invention are contemplated for use with any such shape or symbol.

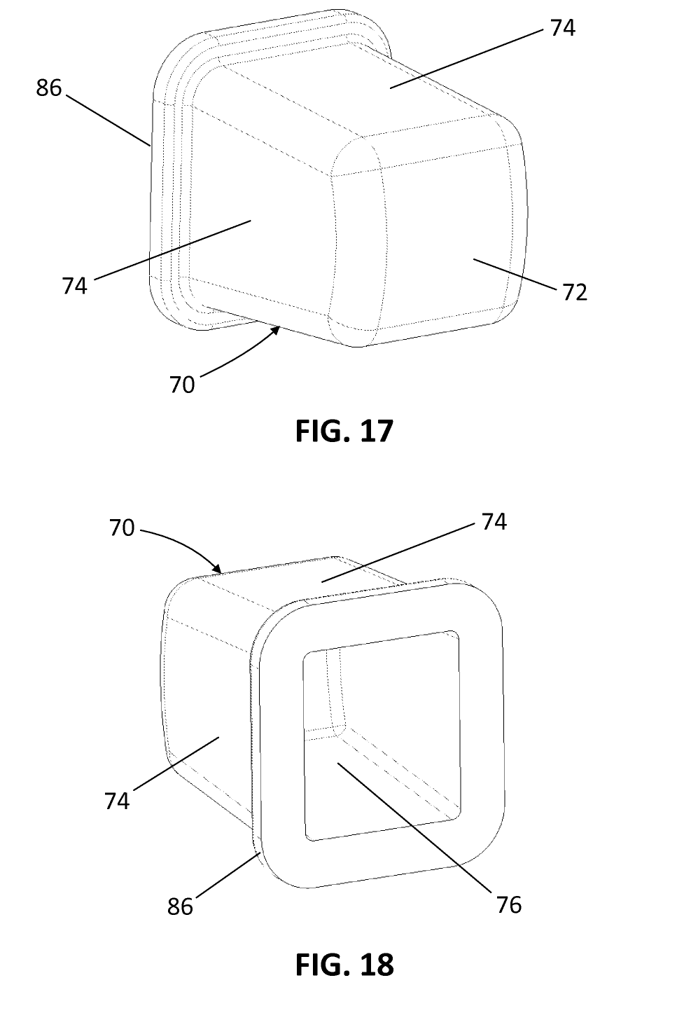

Turning now to FIGS. 17-19, an additional embodiment of the switch identification cover, sheath, or boot is illustrated.

Turning now to FIGS. 17-18, isometric views of the switch identification cover, sheath, or boot 70, in accordance with an embodiment of the present invention. In this embodiment there may be a shoulder, rim, or lip 86 which protrudes from the side walls 74. In this embodiment the lip 86 has a square cross sectional shape but in other embodiments the lip 86 may be a different shape or size.

According to this embodiment of the present invention, the benefit of the lip 86 in this embodiment is that the switch identification cover, sheath, or boot 70 may be easier to install onto the switch 78. The lip 86 would give the user a mechanical advantage or in other words something good to push on during the assembly process. This could allow for a more secure and robust attachment of the switch identification cover, sheath, or boot 70 to the switch 78. This could make the switch identification cover, sheath, or boot 70 less likely to inadvertently fall off of the switch 78.

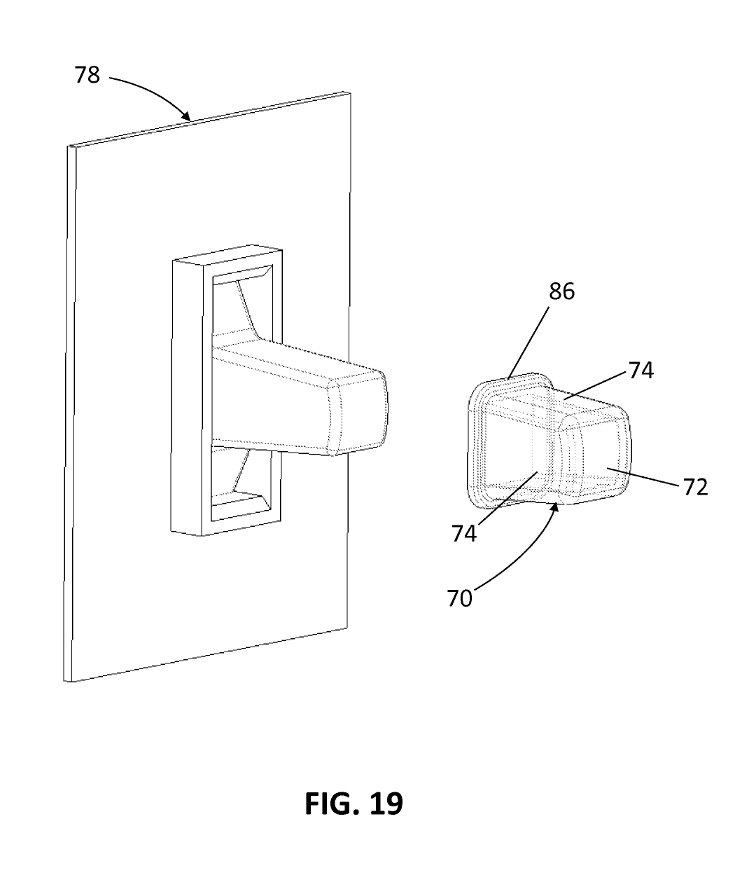

Turning now to FIG. 19, an illustration of a switch identification cover aligned with a switch, in accordance with an embodiment of the present invention. In this illustration, the switch identification cover, sheath, or boot 70 is aligned with the switch 78, such that the four side walls 74 and the end wall 72 are positioned to fit over the projected portion of the switch 78.

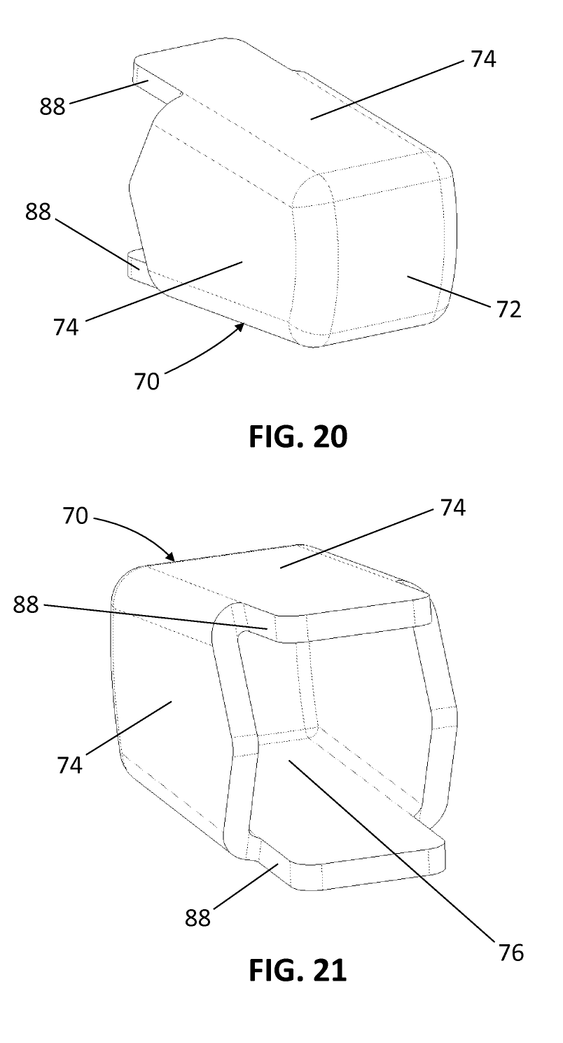

Turning now to FIGS. 20-22, an additional embodiment of the switch identification cover, sheath, or boot is illustrated.

Turning now to FIGS. 20-21, isometric views of the switch identification cover, sheath, or boot 70, in accordance with an embodiment of the present invention. In this embodiment there is a rib, wall, or flap 88 which protrudes parallel from the top and bottom side walls 74. In this embodiment the flap 88 has a rectangular shape but in other embodiments the flap 88 may be configured of any suitable shape and size.

According to this embodiment of the present invention, the benefit of the flap 88 is that the switch identification cover, sheath, or boot 70 may have a better attachment to the switch 78 to which it is coupled. The reason for this is increased contact surface area between the switch identification cover, sheath, or boot 70 and the switch 78. This could allow for a more secure and robust attachment of the switch identification cover, sheath, or boot 70 to the switch 78. This vacuum attachment could make the switch identification cover, sheath, or boot 70 less likely to inadvertently fall off of the switch 78.

According to this embodiment of the present invention, the flap 88 may allow for a more aesthetically pleasing appearance in this embodiment. In a preferred embodiment, the flap 88 covers more of the switch 78 it may result in a more cohesive and integrated appearance.

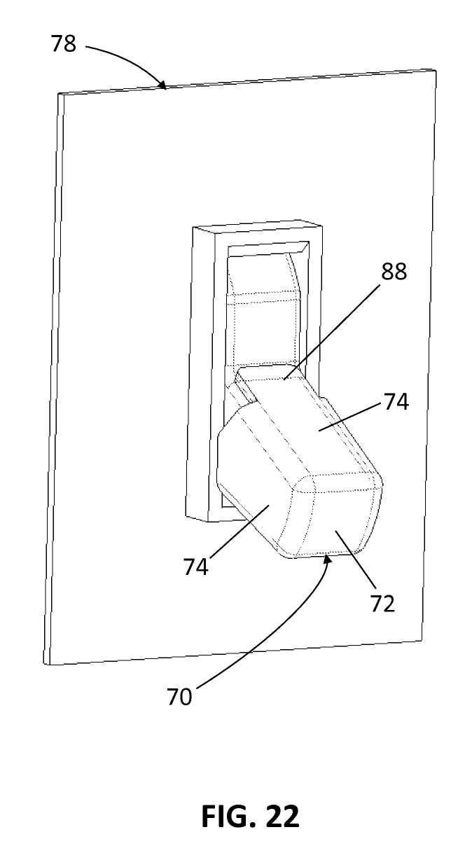

Turning now to FIG. 22, an illustration of a switch identification cover attached to a switch, in accordance with an embodiment of the present invention. In this illustration, the flap 88 of the switch identification cover, sheath, or boot 70 is positioned to create a more secure attachment with the switch 78.

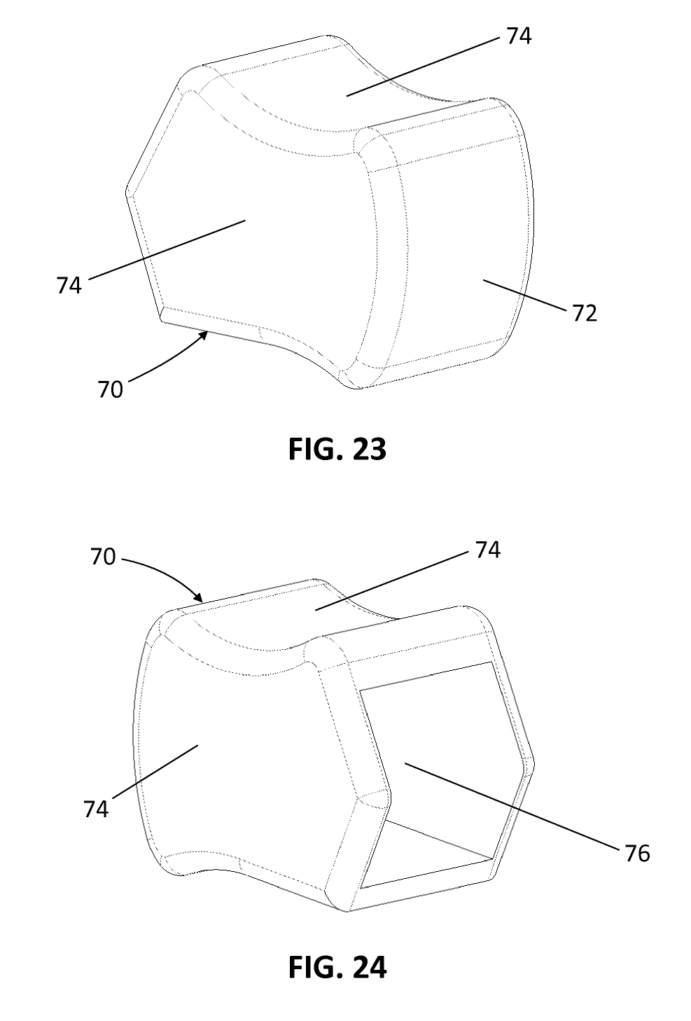

Turning now to FIGS. 23-25, an additional embodiment of the switch identification cover, sheath, or boot is illustrated.

Turning now to FIGS. 23-24, isometric views of the switch identification cover, sheath, or boot 70, in accordance with an embodiment of the present invention. In this embodiment the top and bottom side walls 74 have a curved shape. In a preferred embodiment, the curved shape may be designed to match the curvature of a user's finger. In the preferred embodiment, the curved geometry this embodiment may be more ergonomic, or in other words, easier, more efficient, and more pleasurable to operate and interact with.

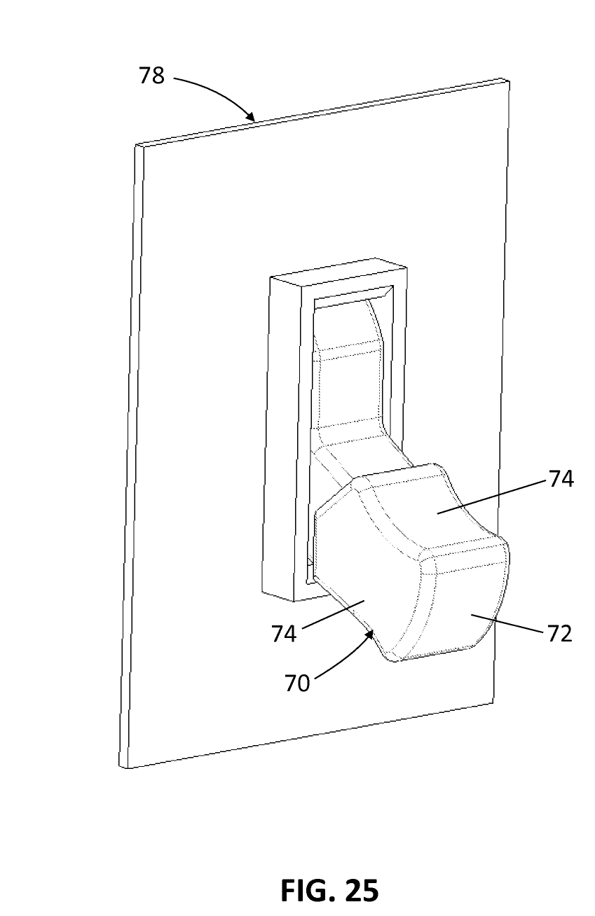

Turning now to FIG. 25, an illustration of a switch identification cover attached to a switch, in accordance with an embodiment of the present invention. In this illustration, it is plainly visible how the curved shape of the top and bottom side walls provides a more ergonomic grip to the switch 78.

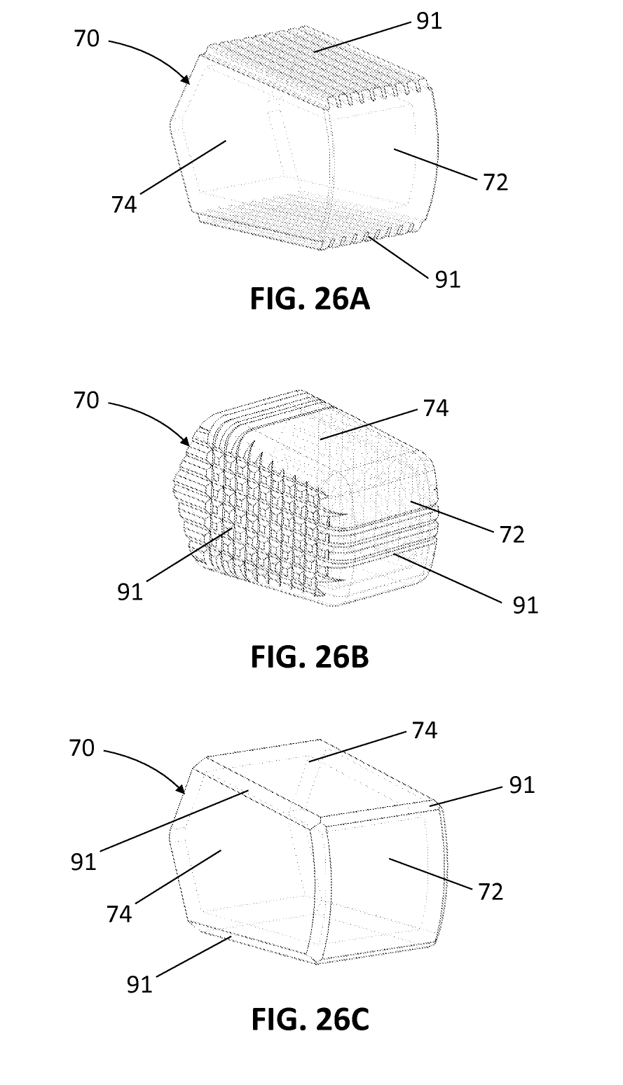

Turning now to FIGS. 26A-C, an additional embodiment of the switch identification cover, sheath, or boot is illustrated.

Turning now to FIGS. 26A-C, isometric views of the switch identification cover, sheath, or boot 70, in accordance with an embodiment of the present invention. In this embodiment the side walls 74 may have a haptic identifier or a texture 91 on them. Alternatively, or in addition, the end wall 72 may have the texture 91 on it. The texture 91 may be achieved in the molding process which creates the switch identification cover, sheath, or boot 70, or the texture 91 could be achieved through secondary processes after molding or by some other means. The texture 91 may be embossed or in other words a protrusion. The texture 91 may be debossed or in other words cut into material. Or the texture 91 may be through holes or in other words cut through the end wall 72 and/or side walls 74. FIGS. 26A-C show variations of some potential texture 91 geometry. In other embodiments the texture 91 could be configured with any suitable shape or size.

According to this embodiment of the present invention, the texture 91 may allow the user to more easily identify the function of the switch 78. The texture 91 may also allow the user to more easily remember the function of the switch 78. Additionally, the texture 91 may improve a users grip when operating this embodiment.

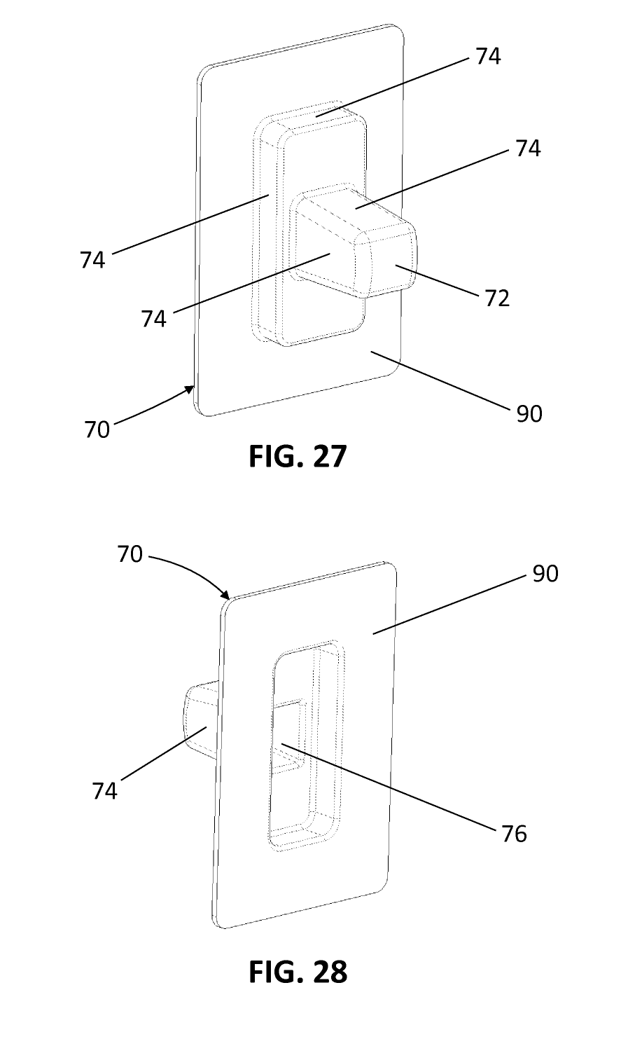

Turning now to FIGS. 27-30, an additional embodiment of the switch identification cover, sheath, or boot is illustrated.

Turning now to FIGS. 27-28, isometric views of the switch identification cover, sheath, or boot 70, in accordance with an embodiment of the present invention. In this embodiment there is a rib, wall, or flange 90 which protrudes from the side walls 74. In this embodiment the flange has a rectangular shape but in other embodiments the flange 90 may be configured with any suitable shape.

According to this embodiment of the present invention, the flange 90 has a uniform cross section. However, the flange 90 geometry may have an accordion or bellows style structure to allow the switch identification cover, sheath, or boot 70 to flex more effectively as the switch 78 is actuated.

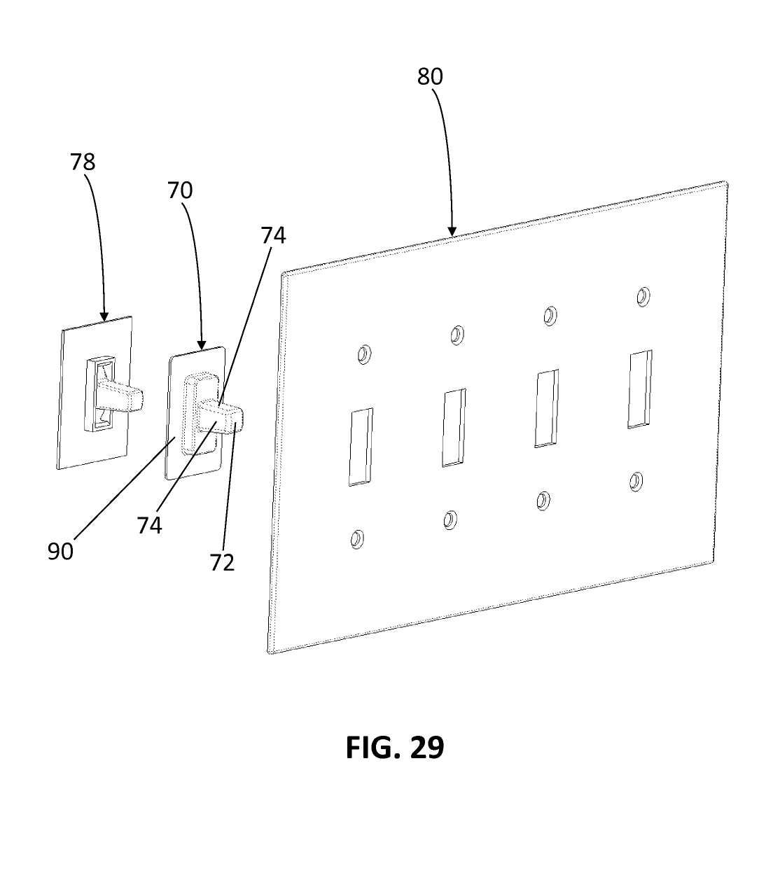

According to this embodiment of the present invention, the switch identification cover, sheath, or boot 70 is attached onto the switch 78 before the face plate 80 is assembled, as shown in FIG. 29. As a result, when this embodiment is fully assembled the switch identification cover, sheath, or boot 70 becomes captured between the back of the face plate 80 and the switch 78. This could allow for a more secure and robust attachment of the switch identification cover, sheath, or boot 70 to the switch 78. This could make the switch identification cover, sheath, or boot 70 less likely to inadvertently fall off of the switch 78.

Turning now to FIG. 29, an illustration of this embodiment as it is being assembled. It is plainly visible that the face plate 80 will secure the switch identification cover, sheath, or boot 70 between the face plate and the switch 78

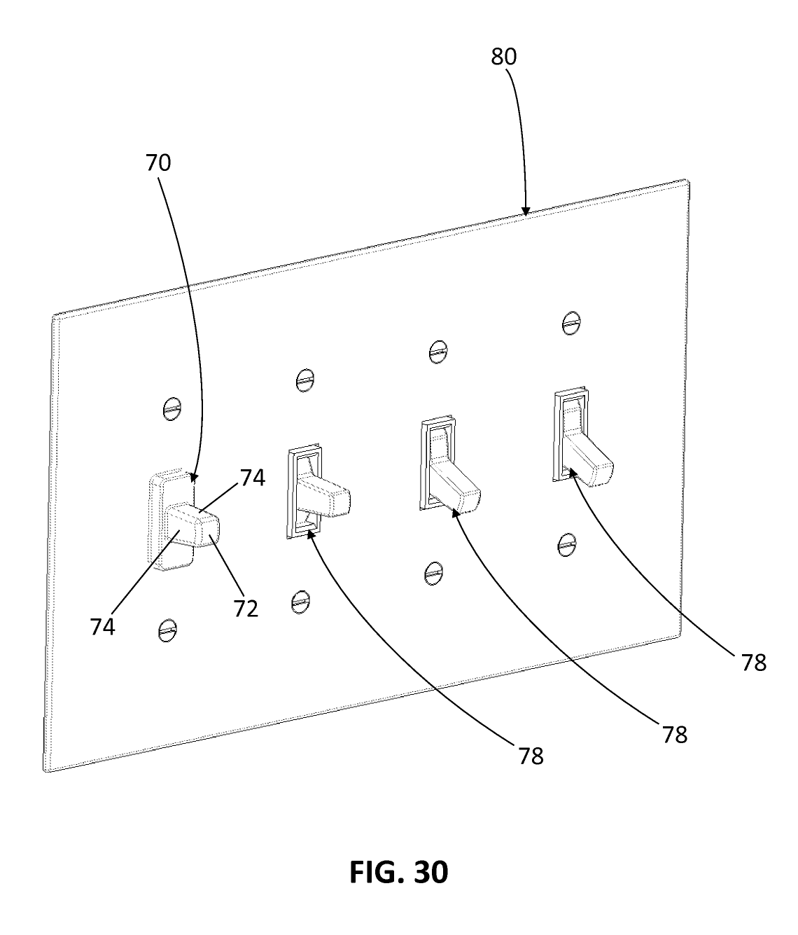

Turning now to FIG. 30, an illustration of this embodiment after it has been assembled.

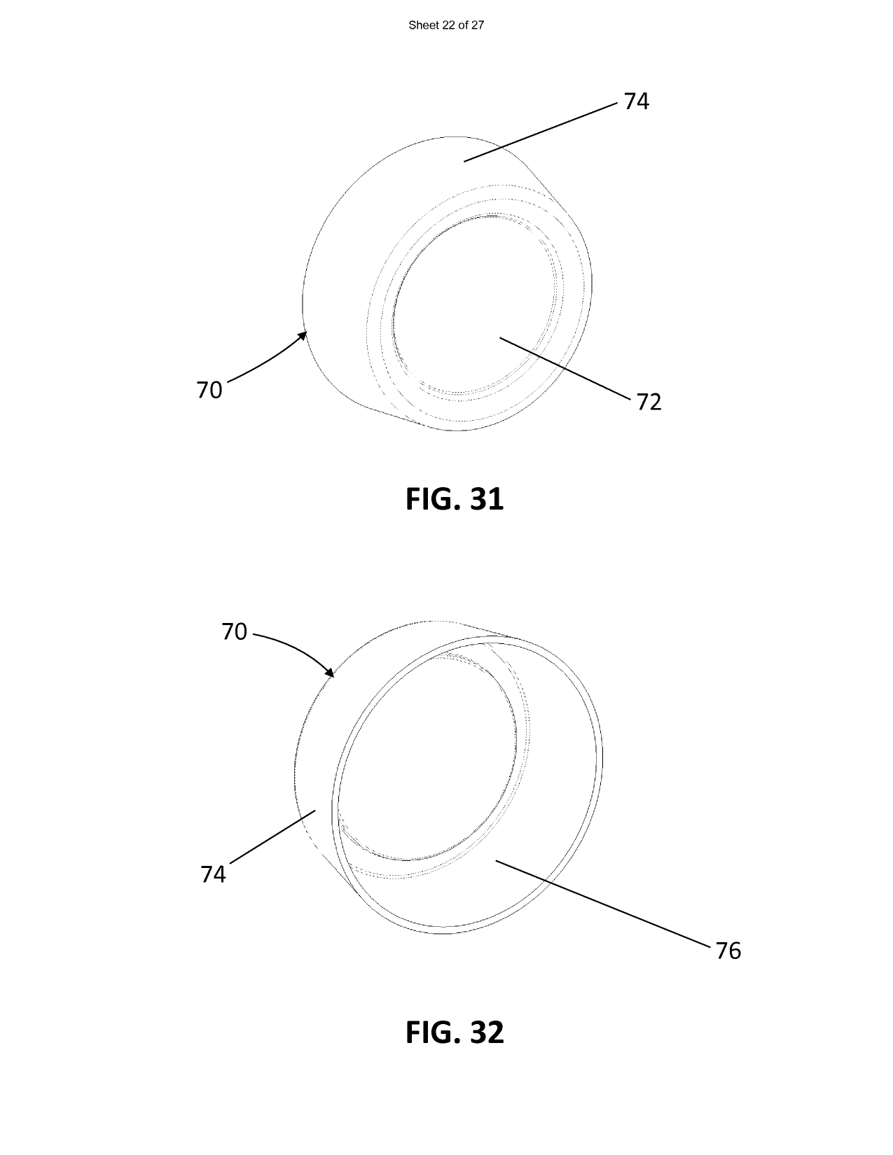

Turning now to FIGS. 31-33, an additional embodiment of the switch identification cover, sheath, or boot is illustrated.

Turning now to FIGS. 31-32, isometric views of the switch identification cover, sheath, or boot 70, in accordance with an embodiment of the present invention. This embodiment demonstrates how a variation in the shape and size of the end wall 72 and side wall 74 could allow the switch identification cover, sheath, or boot 70 to be assembled on to a different style of switch 78. In this embodiment the switch 78 has a circular shape, as would commonly found on conventional dimmer switches.

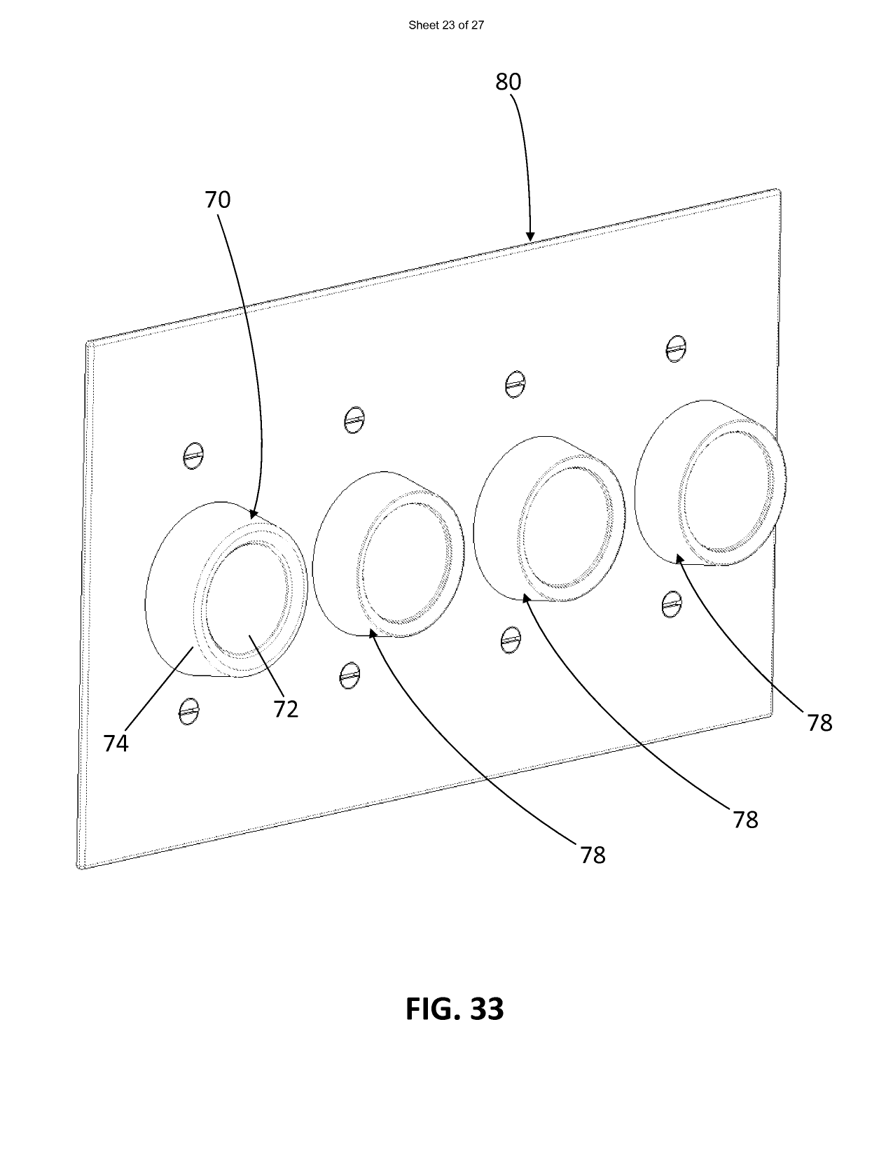

Turning now to FIG. 33, an illustration of the switch identification cover, sheath, or boot 70 of this embodiment attached to the switch 78 of this embodiment.

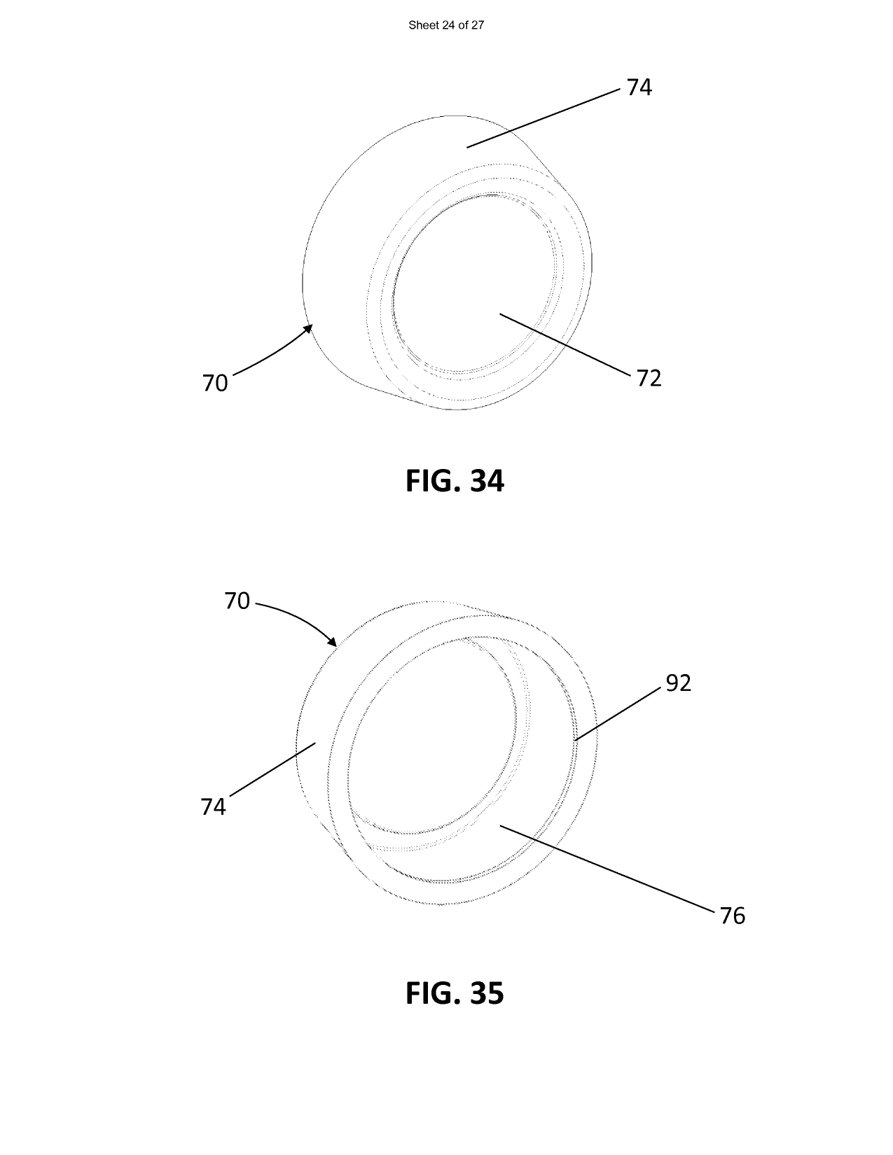

Turning now to FIGS. 34-36, an additional embodiment of the switch identification cover, sheath, or boot is illustrated.

Turning now to FIGS. 34-35, isometric views of the switch identification cover, sheath, or boot 70, in accordance with an embodiment of present invention. In this embodiment there may be a rib 92 protruding inwards off of the side wall 74. In this embodiment the rib may have a rectangular cross sectional shape, but in other embodiments the rib 92 may have a different cross sectional shape or size.

According to this embodiment of the present invention, the benefit of the rib 92 in this embodiment is that it allows the switch identification cover, sheath, or boot 70 to wrap around and behind the switch 78. In a preferred embodiment, this could allow for a more secure and robust attachment of the switch identification cover, sheath, or boot 70 to the switch 78. This could make the switch identification cover, sheath, or boot 70 less likely to inadvertently fall off of the switch 78.

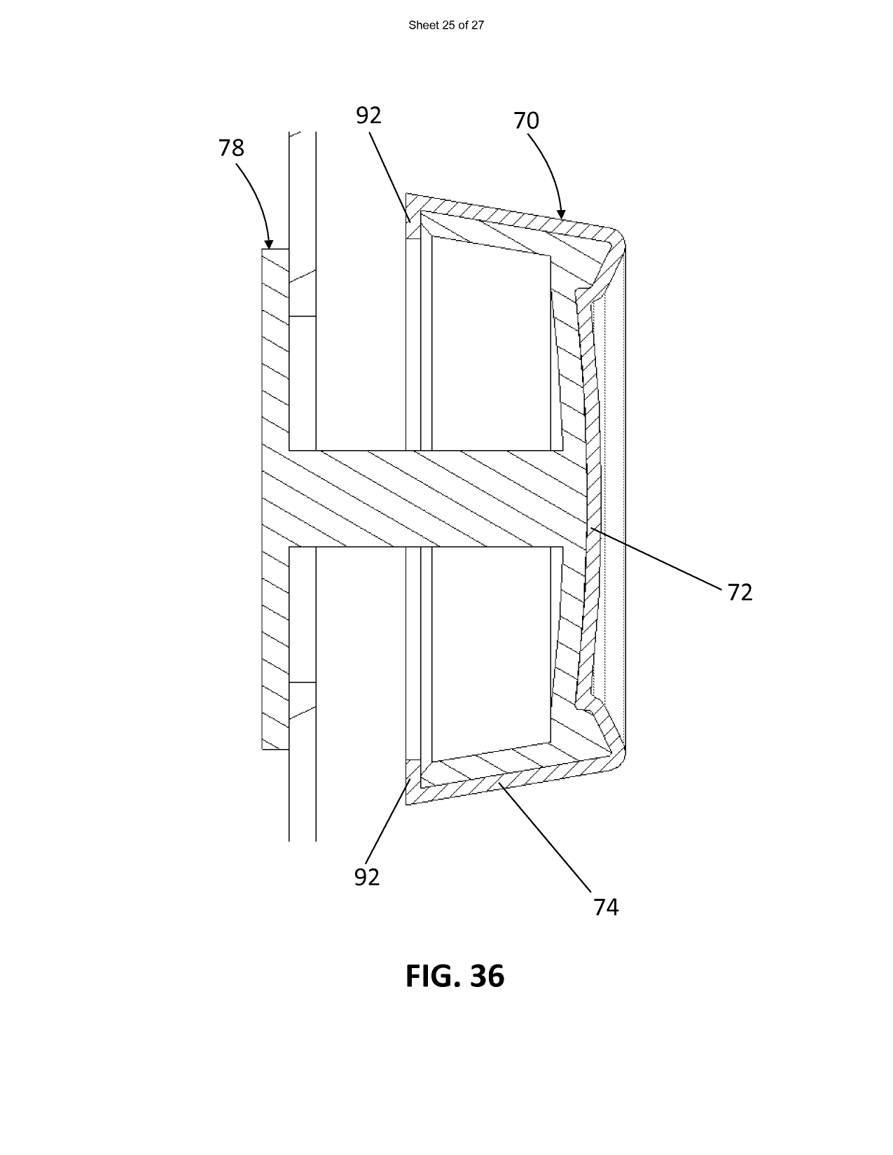

Turning now to FIG. 36, a cross-sectional view of this embodiment from the side is shown. This cross sectional view more clearly demonstrates how the rib 92 engages with the switch 78.

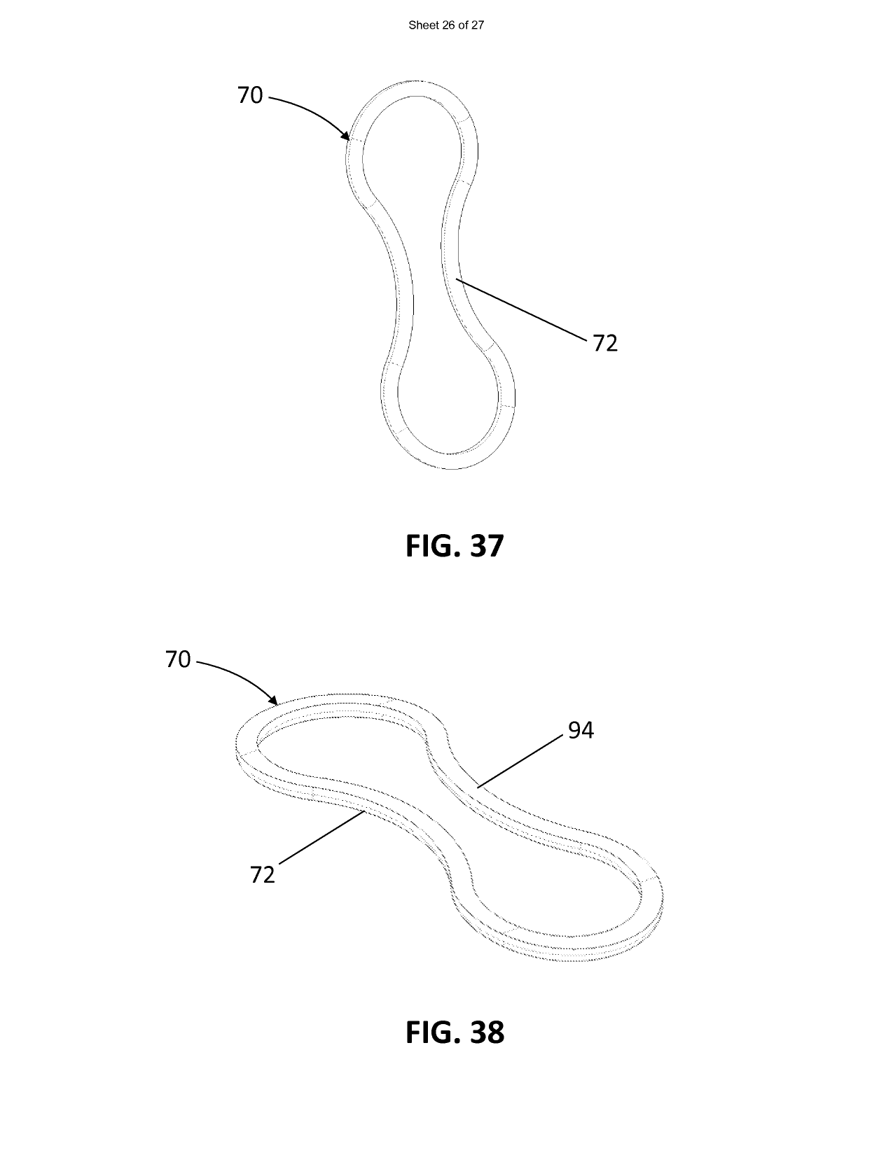

Turning now to FIGS. 37-39, an additional embodiment of the switch identification cover, sheath, or boot is illustrated.

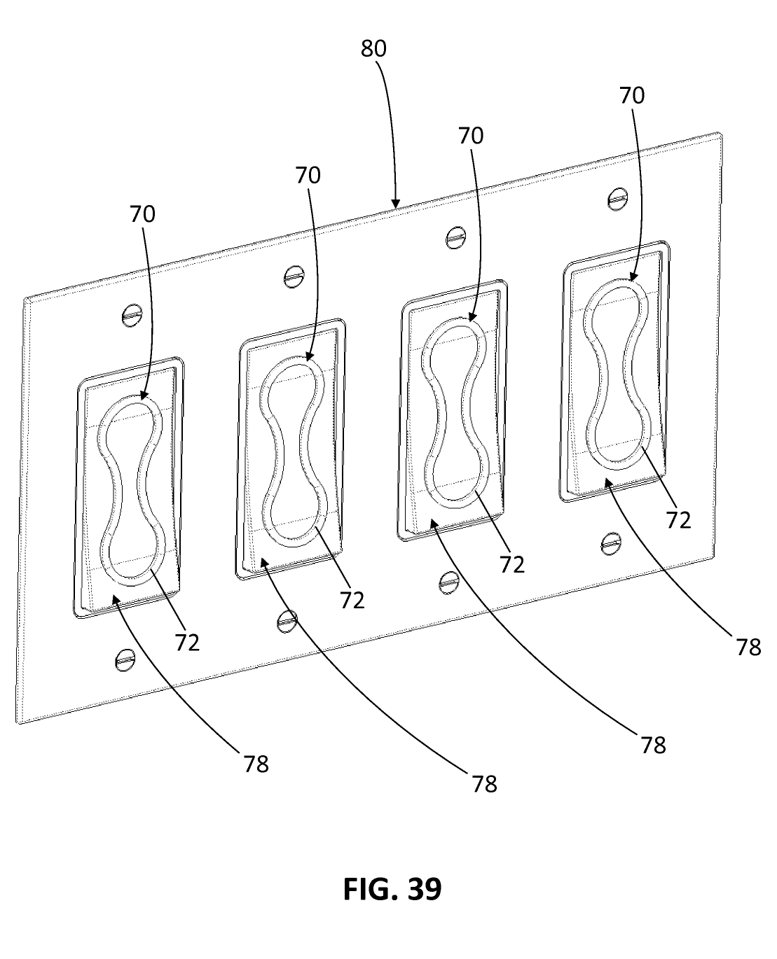

Turning now to FIGS. 37-38, isometric views of the switch identification cover, sheath, or boot 70, in accordance with an embodiment of the present invention. In this embodiment switch identification cover, sheath, or boot 70 may take on a shape and size which could fit more appropriately onto a flat rectangular style switch 78, as shown in FIG. 39. In this embodiment the switch identification cover, sheath, or boot 70 has a front wall 72, which is the front side of the switch identification cover, sheath, or boot 70 and a back wall 94 which is the rear side of the switch identification cover, sheath, or boot 70. In this embodiment the back wall 94 may be coated with an adhesive. The adhesive may be a temporary adhesive or a permanent adhesive or could be somewhere in between temporary and permanent. In other embodiments, adhesive may also coat the inside of the side walls. One of ordinary skill in the art would appreciate that there are numerous suitable adhesives and placement areas for the adhesive, and embodiments of the present invention are contemplated for use with any such adhesive or adhesive placement.

According to this embodiment of the present invention, the benefit of applying an adhesive coating to the back wall 94 is that it allows the switch identification cover, sheath, or boot 70 to be assembled to the surface of a switch 78 without requiring the switch identification cover, sheath, or boot 70 to have any side walls. Some switches 78 may prevent the switch identification cover, sheath, or boot 70 from having side walls, such as the switches 78 shown in FIG. 39. In this embodiment, the switch identification cover, sheath, or boot 70 would attach to the surface of the switch as shown in FIG. 39.

According to this embodiment of the present invention, the front wall 72 of the switch identification cover, sheath, or boot 70 may configured with a tactile surface element. In a preferred embodiment, the tactile surface element is configured to serve as a haptic identifier for the switch surface. The haptic identifier could assist a user in identifying the proper switch by touch alone, for example by marking the border between two or more switches. In the preferred embodiment, the tactile element may also be configured to enhance a user's grip with switch surface when the user is actuating the switch. One of ordinary skill in the art would appreciate that there are many useful functions for a tactile surface element on the front wall of the switch identification cover, sheath, or boot, and embodiments of the present invention are contemplated for use with any such function.

According to this embodiment of the present invention, the switch identification cover, sheath, or boot 70 is a bar that forms a shaped loop. In the preferred embodiment, the switch identification cover, sheath, or boot 70 is a shaped-loop with a void formed on the interior portion of the shaped-loop. The void formed on the interior of the loop could assist a user in actuating a switch by providing a depressed area within the walls of the loop so that the user knows when their hand is on the switch surface. In the preferred embodiment, the switch identification cover, sheath, or boot 70 could be a shaped-loop of any shape, including, but not limited to circle shaped-loops, squares shaped-loops, rectangle shaped-loops, triangle shaped-loops, oval shaped-loops, and free-form shaped loops. In FIGS. 37-39, the switch identification cover, sheath, or boot 70 is a free-form shaped-loop. One of ordinary skill in the art would appreciate that the switch identification cover, sheath, or boot could be formed of any shape, and embodiments of the present invention are contemplated for use with any such shape.

Turning now to FIG. 39, an illustration of the switch identification cover, sheath, or boot 70 of this embodiment assembled to the switches 78 of this embodiment is shown.

According to this embodiment of the present invention, the switch identification cover, sheath, or boot may be configured with one or more identification features. In a preferred embodiment, the identification features include, but are not limited to, a hole, an icon or symbol, one or more curved side walls, and haptic identifiers. In the preferred embodiment, a switch identification cover may include one or more of any individual identification features, as well as any combination of different identification features. In the preferred embodiment, the identification features could be configured on one or more sidewalls of the switch identification cover, as well as the end wall. Each of these one or more identification features are discussed above in relation to the various embodiments of the present invention. One of ordinary skill in the art would appreciate there are many suitable identification features that could be configured on a switch identification cover, and embodiments of the present invention are contemplated for use with any such identification features.

While the above description contains many specificities, these should not be construed as limitations on the scope, but rather as an exemplification of one [or several] preferred embodiments thereof. Many other variations are possible.

Additionally, a slightly different approach could be taken with some of the embodiments where the switch identification cover, sheath, or boot features are actually fully integrated into the switch. In other words the switch and the switch identification cover, sheath, or boot become one. With this approach, some of the benefits could be achieved with a reduction in number manufactured parts required.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A switch identification cover apparatus, said apparatus comprising:
one or more side walls interconnected to form a containment space configured to enclose at least a portion of a switch such that said switch identification cover apparatus is securely retained upon said switch.

2. The apparatus of claim 1, further comprising an end wall interconnected with said one or more side walls to from said containment space, wherein said end wall further defines said containment space.

3. The apparatus of claim 1, further comprising one or more identification features, wherein one or more identification features are selected from a group of identification features comprising one or more holes, one or more symbols, one or more curved side walls, and one or more haptic identifiers.

4. The apparatus of claim 3, wherein said one or more identification features are configured in said one or more side walls.

5. The apparatus of claim 3, wherein said one or more identification features are configured in said end wall.

6. The apparatus of claim 1, further comprising a lip, wherein said lip is connected to one or more of said one or more side walls and is configured to assist a user with installation of said switch identification cover apparatus.

7. The apparatus of claim 1, further comprising a flap, wherein said flap is connected to and extends one or more of said one or more side walls and is configured to securely retain said switch identification cover apparatus upon said switch.

8. The apparatus of claim 1, further comprising a flange, wherein said flange is an extension connected to each of said one or more side walls that seals said switch behind a face plate when said switch identification cover apparatus is arranged over said switch and behind said face plate covering said switch.

9. The apparatus of claim 8, wherein said flange is further configured with an accordion-like structure to provide sufficient flexibility so as to allow said switch to be operated.

10. The apparatus of claim 1, further comprising a rib, wherein said rib is attached to one or more of said one or more side walls and is configured to secure said switch identification cover apparatus on said switch by physically engaging with one or more edges of said switch.

11. A switch identification cover apparatus, said apparatus comprising:
a front wall interconnected to a rear wall,
wherein said rear wall is configured with an adhesive component,
wherein said adhesive component is configured to securely affix said rear wall of said switch identification cover apparatus to a switch surface.

12. The apparatus of claim 11, wherein said front wall is configured with a tactile surface element to identify and enhance the grip characteristics of said switch surface.

13. The apparatus of claim 11, further comprising one or more side walls interconnected between said front wall and said rear wall.

14. The apparatus of claim 11, wherein said switch identification cover apparatus is bar that forms a shaped-loop with a void formed on the interior portion of said shaped-loop.

15. The apparatus of claim 14, wherein said shaped-loop is selected from a group shaped-loops comprising circle shaped-loops, squares shaped-loops, rectangle shaped-loops, triangle shaped-loops, oval shaped-loops, and free-form shaped loops.

16. The apparatus of claim 11, wherein said adhesive component is further configured on said one or more side walls.

17. The apparatus of claim 11, wherein said adhesive component is a temporary adhesive.

18. The apparatus of claim 11, wherein said adhesive component is a permanent adhesive.

19. A method for identifying a switch, said method comprising the steps of:
attaching to a switch a switch identification cover apparatus comprising one or more side walls interconnected to form a containment space configured to enclose at least a portion of said switch such that said switch identification cover apparatus is securely retained upon said switch; and
identifying said switch based at least in part on said switch cover identification cover apparatus that is attached to said switch.
